(19) United States
(12) Patent Application Publication
(10) Pub. No.: US 2025/0166950 A1
(43) Pub. Date: May 22, 2025

(54) DIRECT CURRENT CONTACTORS WITH IMPROVED EVACUATION AIR PATHWAYS

(71) Applicant: SENSATA TECHNOLOGIES, INC., ATTLEBORO, MA (US)

(72) Inventors: MATTHEW R. MONTEIRO, TAUNTON, MA (US); MATTHEW C. RYDER, HOLLISTON, MA (US); CALVIN S. REUTER, CUMBERLAND, RI (US)

(21) Appl. No.: 18/951,602

(22) Filed: Nov. 18, 2024

Related U.S. Application Data
(60) Provisional application No. 63/601,466, filed on Nov. 21, 2023.

(51) Int. Cl. H01H 50/12; H01H 49/00; H01H 50/54

(52) U.S. Cl. CPC H01H 50/12; H01H 49/00; H01H 50/54

(57) ABSTRACT

In a particular embodiment, a DC contactor with improved evacuation air pathways is described that includes a weld plate having a port. The contactor also includes an arc chamber and a plunger tube with a cavity that is interconnected to the port and the arc chamber by air pathways. In this embodiment, the contactor also includes an upper static core disposed at least partially within the plunger tube and a shaft assembly coupled to a shaft disposed within the upper static core. The contactor also includes an arc shield within the arc chamber and one or more vent pathways in one or more of the arc shield, the shaft assembly, or the upper static core. In this embodiment, the one or more vent pathways in the air pathways interconnect the port, the arc chamber, and the plunger tube.

### BACKGROUND

Electromechanical switching devices, such as contactors and relays, play a crucial role in managing and distributing electrical power within various systems by allowing controlled connection and disconnection of high current circuits. These devices are particularly important in electric vehicles, where they contribute to efficient power management and safety. In a typical electric vehicle, one or more high-voltage battery packs supply power to the electric motor via a main contactor that connects the battery to the vehicle's power distribution network. This main contactor operates as an electromechanical switch, capable of opening or closing high-current pathways, thus regulating the power flow from the battery packs to the motor and other vehicle components.

Since the main contactor must reliably handle large electrical loads, it is designed to withstand high currents and maintain stable connections over prolonged usage. However, the interior components of the contactor, such as metal contacts, are susceptible to degradation through corrosion if exposed to air and moisture. To mitigate this, the internal chamber of the contactor is evacuated, removing air and water vapor to create a sealed environment. This not only prolongs the life of the contactor but also ensures consistent performance by reducing the risk of contact resistance changes or short-circuiting due to corrosion.

### SUMMARY

Embodiments of the present disclosure describe direct current (DC) contactors with improved evacuation air pathways specifically designed to optimize vacuum flow rates for rapid evacuation and to reduce contact resistance. These advancements include strategically placed vent pathways in one or more key components, such as an arc shield, a shaft assembly, and an upper static core. By accelerating evacuation speed, these design improvements enable more cost-effective manufacturing processes. Additionally, reduced contact resistance minimizes heat generation during operation, enhancing efficiency. For instance, vent pathways can be implemented using cavities or apertures within the components to facilitate these benefits.

In a particular embodiment, a DC contactor with improved evacuation air pathways is described that includes a weld plate having a port. The contactor also includes an arc chamber and a plunger tube with a cavity that is interconnected to the port and the arc chamber by air pathways. In this embodiment, the contactor also includes an upper static core disposed at least partially within the plunger tube and a shaft assembly coupled to a shaft disposed within the upper static core. The contactor also includes an arc shield within the arc chamber and one or more vent pathways in one or more of the arc shield, the shaft assembly, or the upper static core. In this embodiment, the one or more vent pathways in the air pathways interconnect the port, the arc chamber, and the plunger tube.

In another embodiment, a method of manufacturing a direct current (DC) contactor assembly with improved evacuation air pathways is described that includes incorporating an upper static core at least partially within a plunger tube. The method also includes coupling the plunger tube to a weld plate having a port and coupling a shaft assembly to the weld plate such that a shaft of the shaft assembly is disposed within the upper static core. In this embodiment, the method also includes forming an arc chamber around the weld plate such that a cavity of the plunger tube is interconnected to the port and the arc chamber by air pathways. The method also includes positioning an arc shield within the arc chamber. In this embodiment, at least one of the arc shield, the shaft assembly, or the upper static core include one or more vent pathways positioned within in the air pathways interconnecting the port, the arc chamber, and the plunger tube.

These and other features, aspects, and advantages of the present disclosure will become better understood when the following detailed description is read with reference to the accompanying drawings in which like characters represent like parts throughout the drawings.

### BRIEF DESCRIPTION OF THE DRAWINGS

FIG. 1A shows a cross section of a conventional DC contactor.

FIG. 1B shows a detailed view of components of the conventional DC contactor shown in FIG. 1A.

FIG. 2A shows a DC contactor with improved evaluation air pathways in accordance with at least one embodiment of the present disclosure.

FIG. 2B shows a detailed view of components of the DC contactor of FIG. 2A.

FIG. 2C shows a detailed view of the DC contactor of FIG. 2A.

FIG. 3 sets forth a flow chart of an example method of improving vacuum evacuation speed on DC contactors in accordance with at least one embodiment of the present disclosure.

FIG. 4 sets forth a flow chart of another example method of improving vacuum evacuation speed on DC contactors in accordance with at least one embodiment of the present disclosure.

FIG. 5 sets forth a flow chart of an example method of manufacturing a DC contactor with improved evacuation air pathways in accordance with at least one embodiment of the present disclosure.

FIG. 6 sets forth a flow chart of another example method of manufacturing a DC contactor with improved evacuation air pathways in accordance with at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Direct current (DC) contactors undergo a purge process during the manufacturing process to remove (e.g., via a pump) oxygen and water vapor from the contactor before sealing it. This prevents the conductive copper elements from oxidizing, which keeps the contact resistance low for the life of the product. Low contact resistance is one of the defining characteristics of an electrical contactor. An economically viable purge process allows residual oxygen and water vapor to be removed from the contactor at high speed. This is accomplished using a combination of vacuum and nitrogen purge; however, the total purge time is dominated by the vacuum process. A vacuum behaves very differently than pressure because the vacuum evacuation time, along with the lowest obtainable vacuum, is strongly influenced by the size and length of vacuum pathways within the product.

DC contactors are generally constructed with two major internal volumes: the arc chamber and the plunger tube. Optimal product performance is obtained by removing all oxygen and water vapor from these two volumes. The pathway connecting them is internal to the product and conventional designs make no attempt to maximize the size of this pathway. It is common for the shaft assembly to cover the opening to the plunger tube. It is also common for the arc shield to block or trap cavities of ambient air within the arc chamber. Small pathways severely restrict vacuum flow and result in long vacuum evacuation times and higher residual amounts of oxygen and water vapor.

Moreover, residual oxygen and water vapor inside the contactor will cause the un-plated copper stationary terminals and the movable contact to oxidize. Oxidized copper has a higher electrical resistance than bare copper and will generate more heat during operation. It is important to remove as much oxygen and water vapor as possible before sealing the contactor to ensure the contact resistance and heat generation remains low for the life of the product. If the internals of the contactor are not properly designed, the evacuation time will be long (leading to higher manufacturing costs) and the levels of residual gas will be higher (leading to lower product performance).

Embodiments in accordance with the present disclosure provide a DC contactor that incorporates vent pathways in one or more of the upper static core, the shaft assembly, or the arc shield to provide a wide air pathway for vacuum evacuation. Increasing the width of the air pathway, increases vacuum capability and shortening evacuation time, thereby leading to improved contactor performance.

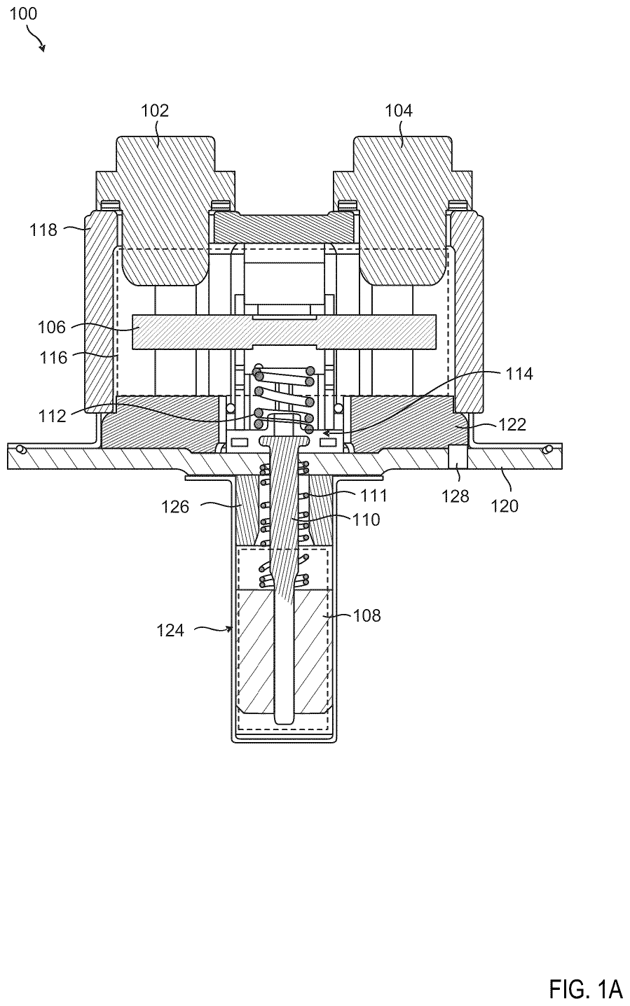

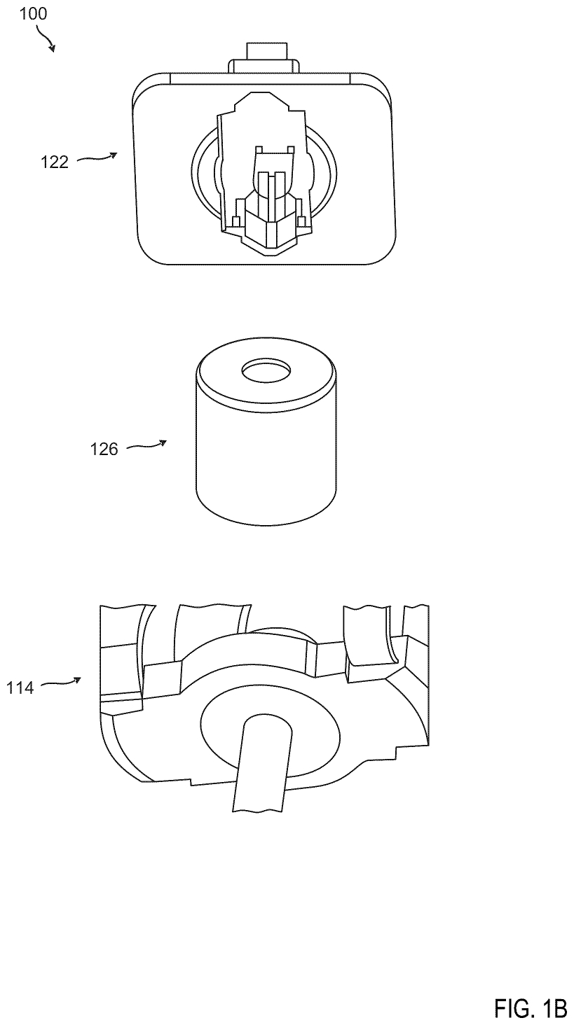

For further explanation, FIG. 1A and FIG. 1B illustrate the components of a DC contactor 100. The contactor 100 includes stationary contacts 102, 104 and a moveable contact 106. The contactor 100 also includes an actuator (i.e., moveable) assembly including a plunger 108 disposed within a plunger tube 124, a shaft 110 driven by the plunger during energization of a solenoid or coil (not pictured in FIG. 1A-B), a plunger spring 111, a contact spring 112, and a shaft assembly 114 that drives the moveable contact 106 into contact with the stationary contacts 102, 104 when the DC contactor is energized. The contactor 100 further includes an arc chamber 116 formed by a housing 118 and a weld plate 120. The arc chamber 116 includes an arc shield 122 in contact with the weld plate 120 at the base of the arc chamber 116. The contactor 100 also includes an upper static core 126 above the plunger tube 124. The shaft extends through the plunger tube 124, the upper static core 126 and into the arc chamber 116 where the shaft 110 is attached to the shaft assembly 114. During manufacture of the contactor 100, a vacuum is created in the contactor using port 128. The air pathway for the vacuum passes through the port 128, under the arc shield 122, under the shaft assembly 114, and between the shaft 110 and the upper static core 126. In this example, the air pathway connecting the arc chamber and a cavity of the plunger tube is internal to the DC contactor and constricted. The shaft assembly covers the opening to the plunger tube and the arc shield blocks or traps the cavities of ambient air within the arc chamber. As explained above, small pathways severely restrict vacuum flow and result in long vacuum evacuation times and higher residual amount of oxygen and water vapor

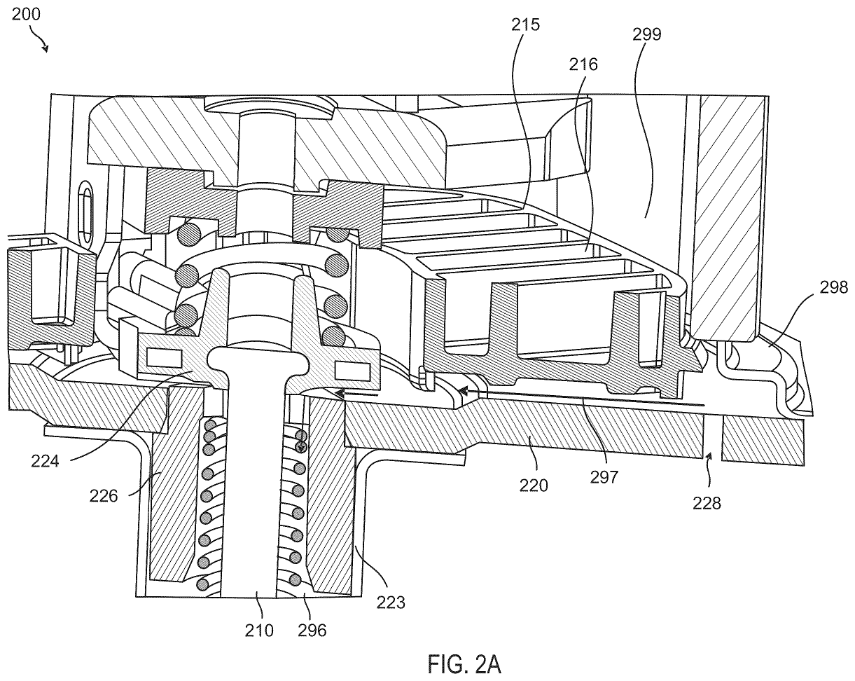

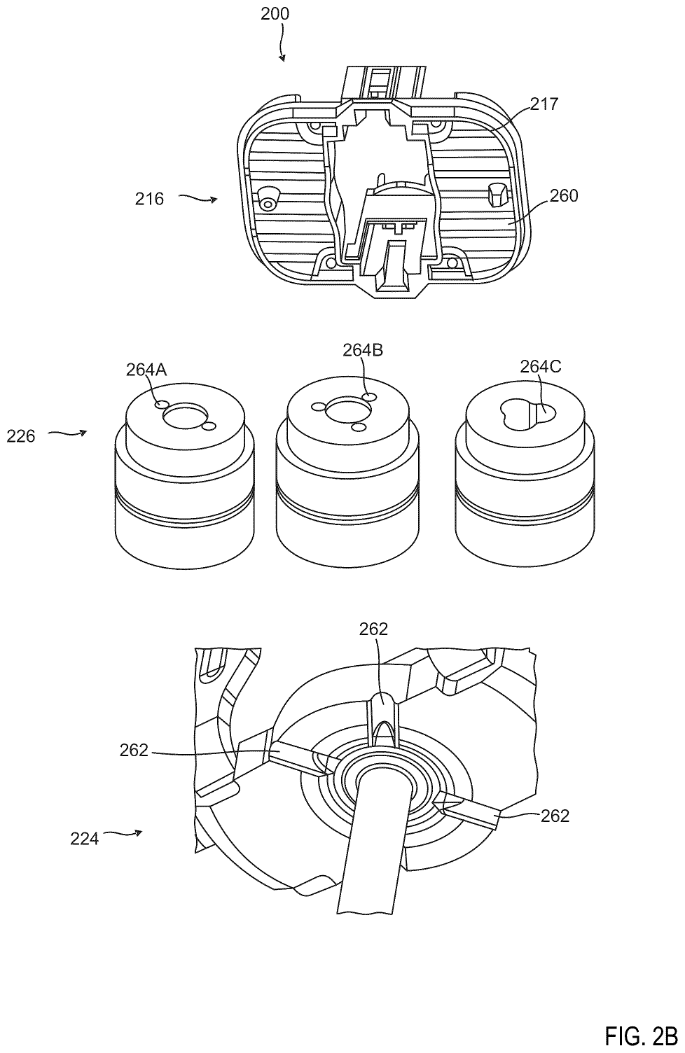

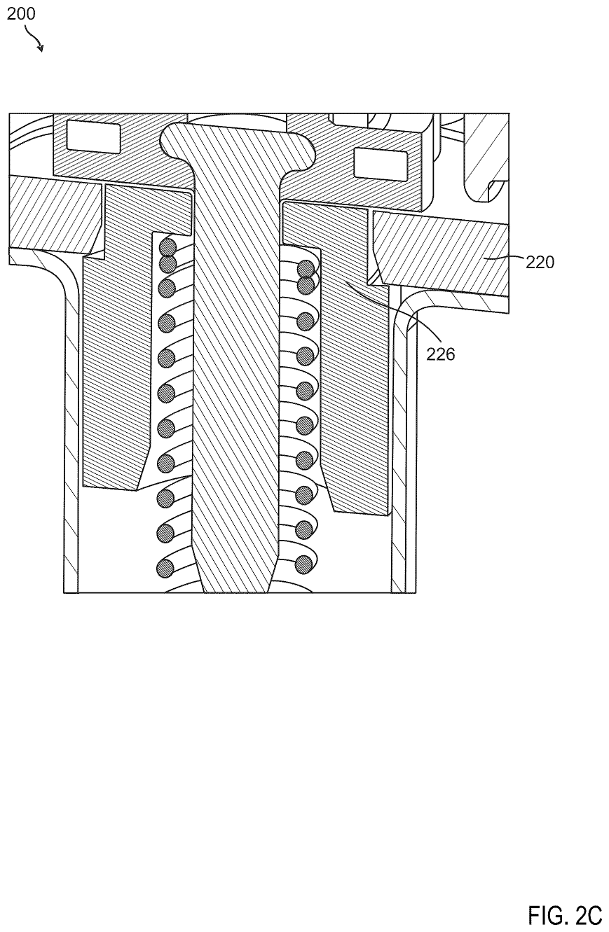

For further explanation, FIGS. 2A and 2B set forth a diagram of a DC contactor with improved evacuation air pathways in accordance with at least one embodiment of the present disclosure. FIG. 2A illustrates a perspective view of a DC contactor 200 and FIG. 2B illustrates a component view of the DC contactor 200. The contactor 200 of FIGS. 2A and 2B is similar to the contactor 100 of FIGS. 1A and 1B in that the contactor 200 also includes components, such as a plunger tube 223, a shaft 210, a upper static core 226, a shaft assembly 224, a weld plate 220, a port 228, an arc chamber 299, an arc shield 216, and housing 298, which perform similar functions to the components of the same name in FIG. 1A-B. However, in the contactor 200 of FIGS. 2A and 2B, vent pathways 260 are added to an underside of the arc shield 216 proximate to the weld plate 220 to facilitate air flow between the underside of the arc shield 216 and the weld plate 220 to the port 228. The shaft assembly 224 also includes vent pathways 262 added to the underside of the shaft assembly 224 to facilitate air flow between the underside of the arc shield 216 and the weld plate 220 to the port 228. In the DC contactor 200, the upper static core 226 includes vent pathways 264 which are added to the shaft opening to facilitate air flow between the shaft 210 and the upper static core 226.

According to embodiments of the present disclosure, vent pathways may be implemented as cavities, through-holes, or apertures of the arc shield, shaft assembly, and upper static core. For example, the vent pathways 260 in FIG. 2B are apertures that have an opening at the top side 215 (visible in FIG. 2A and bottom side 217 (visible in FIG. 2B) of the arc shield 216, which allow airflow through the arc shield 216. As another example, the vent pathways 262 underneath the shaft assembly 224 are cavities that create a space between the shaft assembly and the weld plate.

In the example of FIG. 2B, three variations of the vent pathways 264 of the upper static core 226A, 226B, 226C are illustrated. In one configuration 226C, three through-holes are positioned on the outside of the center shaft opening of the upper static core 226 without expanding the center shaft opening. In another configuration 226A, two through-holes are separate from and parallel to the center shaft opening of the upper static core. In the third configuration 226B, three through-holes are separate from and parallel to the center shaft opening of the upper static core. In all of these configurations, the circumference of the center shaft opening is not enlarged. As explained above, a larger shaft opening in the upper static core is not desirable as it degrades position of the shaft 210 within the shaft opening. The vent pathways 264 allow air flow while maintaining alignment of the shaft axis with the axis of the shaft opening.

The vent pathways 260, 262, 264 facilitate air flow between the port 228, the arc chamber 299, and a cavity 296 of the plunger tube 223 for a faster and more complete evacuation. Increased vacuum results in shorter vacuum evacuation times and a lower residual amount of oxygen and water vapor in the DC contactor 200. As such, the purge process during the manufacturing process to remove oxygen and water vapor from the contactor before sealing it is shortened. Further, the vent pathways 260, 262, 264 increase the removal of oxygen and water vapor, which mitigates oxidation of the conductive copper elements and keeps the contact resistance low for the life of the product. Thus, an improved air pathway 297 (indicated by arrows) is created from the port 228 to under the arc shield 216 to under the shaft assembly 224 to between the shaft 210 and the upper static core 226. Readers of skill in the art will realize that in other embodiments, only one or more of the arc shield, the shaft assembly, or the upper static core include one or more vent pathways in the air pathways interconnecting the port, the arc chamber, and the plunger tube. After the gas is vacuum removed from the interior chambers of the DC contactor 500, the port 228 is sealed, creating a hermetically sealed enclosure for the arc chamber and the plunger tube.

For further explanation, FIG. 2C sets forth a partial view of DC contactor 200 for improving vacuum evacuation speed on DC contactors in accordance with at least one embodiment of the present disclosure. In a conventional DC contactor, the weld plate is disposed on top of the upper static core. In accordance with the present disclosure, the upper static core 226 extends through the weld plate 220. In this way, air flow through the vent pathways 264 in the upper static core 226 is increased.

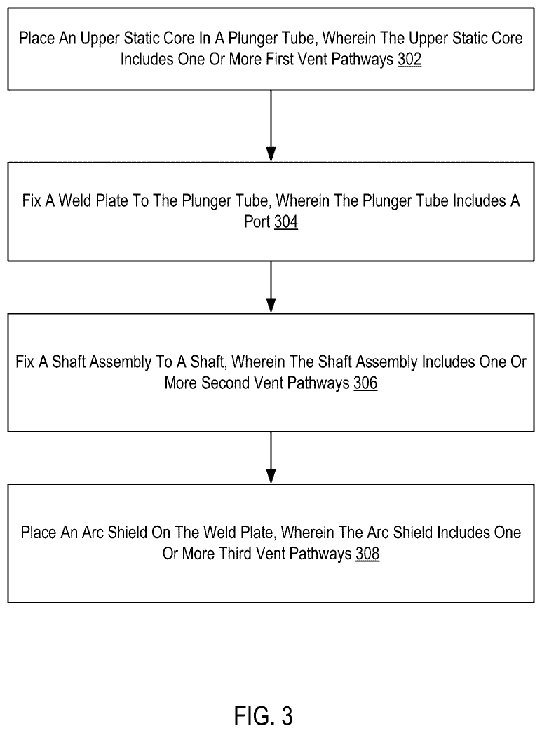

For further explanation, FIG. 3 sets forth a flow chart of an example method for improving vacuum evacuation speed on DC contactors in accordance with the present disclosure. The method of FIG. 3 includes placing 302 an upper static core in a plunger tube, wherein the upper static core includes one or more first vent pathways. For example, the upper static core may be the same as or similar to the upper static core 226 shown in FIGS. 2A to 2C. Placing 302 the upper static core may be carried out by inserting the upper static core into the plunger tube as shown in FIGS. 2A and 2C.

The method of FIG. 3 also includes fixing 304 a weld plate to the plunger tube, wherein the plunger tube includes a port. Fixing 304 a weld plate to the plunger tube, wherein the plunger tube includes a port may be carried out as shown in FIGS. 2A to 2C.

The method of FIG. 3 also includes fixing 306 a shaft assembly to a shaft, wherein the shaft assembly includes one or more second vent pathways. For example, the shaft assembly may be the same as or similar to the shaft assembly 224 shown in FIGS. 2A to 2C. Fixing 306 a shaft assembly to a shaft, wherein the shaft assembly includes one or more second vent pathways may be carried out as shown in FIGS. 2A to 2C.

The method of FIG. 3 also includes placing 308 an arc shield on the weld plate, wherein the arc shield includes one or more third vent pathways. For example, the arc shield may be the same as or similar to the arc shield 216 shown in FIGS. 2A to 2C. Placing 308 an arc shield on the weld plate, wherein the arc shield includes one or more third vent pathways may be carried out as shown in FIGS. 2A to 2C.

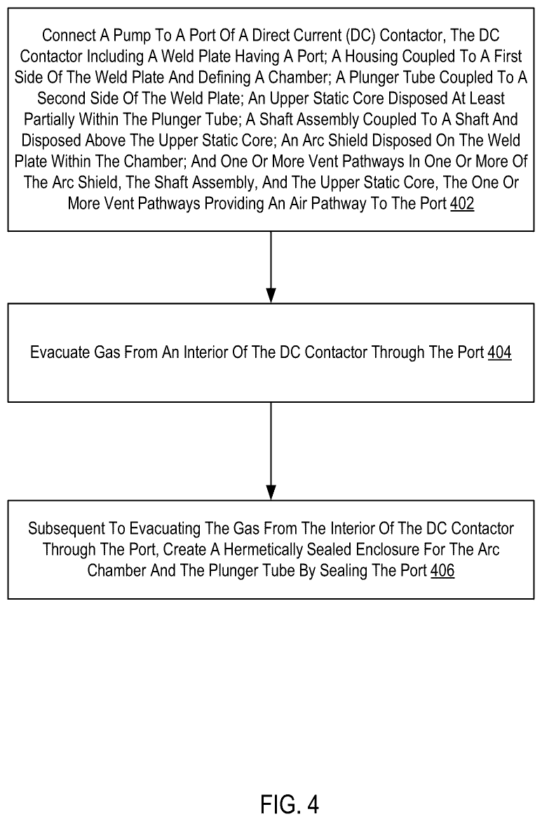

For further explanation, FIG. 4 sets forth a flow chart of an example method for improving vacuum evacuation speed on DC contactors in accordance with the present disclosure. The method of FIG. 4 includes connecting 402 a pump to a port of a DC contactor. In the example of FIG. 4, the DC contactor includes a weld plate having a port, a housing coupled to a first side of the weld plate and defining a chamber, and a plunger tube coupled to a second side of the weld plate. The DC contactor also includes an upper static core disposed at least partially within the plunger tube, a shaft assembly coupled to a shaft and disposed above the upper static core, an arc shield disposed on the weld plate within the chamber, and one or more vent pathways in one or more of the arc shield, the shaft assembly, and the upper static core. In the example of FIG. 4, the one or more vent pathways provide an air pathway to the port.

The method of FIG. 4 also includes evacuating 404 gas from the interior of the DC contactor through the port. Evacuating 404 gas from the interior of a DC contactor through the port involves connecting a vacuum pump to the evacuation port and securely routing the gas into a recovery tank or containment system. The pump creates a vacuum, drawing the gas out while ensuring no leaks occur during the process.

In addition, the method of FIG. 4 also includes subsequent to evacuating the gas from the interior of the DC contactor through the port, creating 406 a hermetically sealed enclosure for the arc chamber and the plunger tube by sealing the port. Sealing the port of the DC contactor after evacuating the gas can be achieved through various methods, depending on the design requirements and materials involved. For example, the port may be sealed using a precision welding process, such as laser welding or TIG (Tungsten Inert Gas). As another example, a soldering or brazing material may be melted and applied to the port to form a seal. In another example, high-strength, airtight epoxy or adhesive is applied to seal the port. As another example, A specialized plug or cap may be inserted into the port and mechanically fastened (e.g., by crimping or threading) or adhered using a sealing material. In some instances, a glass-to-metal seal may be used, where a glass material is melted and bonded to the metal port, creating an airtight and hermetic seal. As another example, a crimping process may be used to mechanically compress a metal collar or seal around the port opening.

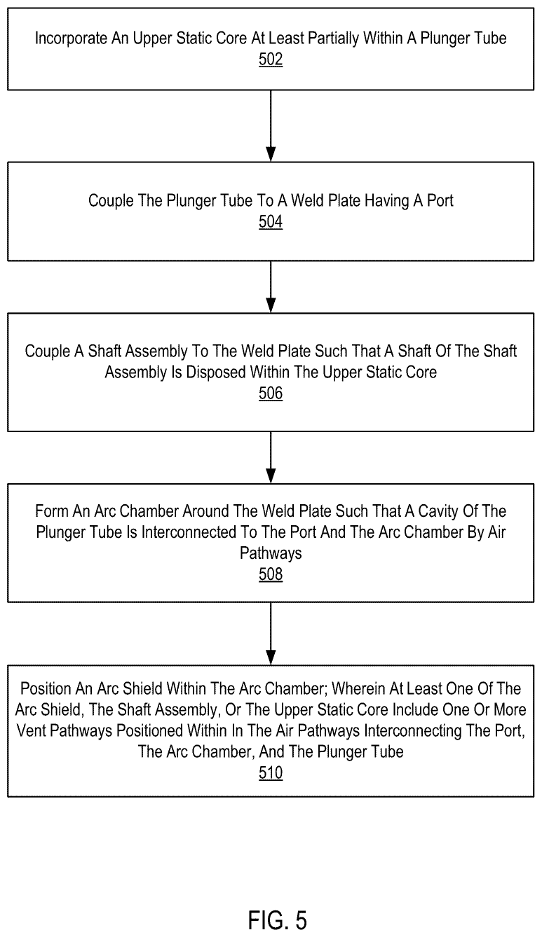

For further explanation, FIG. 5 sets forth a flow chart of an example method for manufacturing a DC contactor with improved evacuation air pathways in accordance with the present disclosure. The method of FIG. 5 includes incorporating 502 an upper static core at least partially within a plunger tube. For example, the upper static core may be the same as or similar to the upper static core 226 shown in FIGS. 2A to 2C and the plunger tube may be the same as or similar to the plunger tube 223 shown in FIGS. 2A to 2C. Incorporating 502 an upper static core at least partially within a plunger tube may be carried out by inserting the upper static core into the plunger tube as shown in FIGS. 2A to 2C.

The method of FIG. 5 also includes coupling 504 the plunger tube to a weld plate having a port. For example, the weld plate may be the same as or similar to the weld plate 220 shown in FIGS. 2A to 2C. Coupling 504 the plunger tube to a weld plate having a port may be carried out by welding the plunger tube to the weld plate.

In addition, the method of FIG. 5 also includes coupling 506 a shaft assembly to the weld plate such that a shaft of the shaft assembly is disposed within the upper static core. For example, the shaft assembly may be the same as or similar to the shaft assembly 224 shown in FIGS. 2A to 2C. Coupling 506 a shaft assembly to the weld plate such that a shaft of the shaft assembly is disposed within the upper static core may be carried out by welding the shaft assembly to the weld plate.

The method of FIG. 5 also includes forming 508 an arc chamber around the weld plate such that a cavity of the plunger tube is interconnected to the port and the arc chamber by air pathways. For example, the arc chamber may be the same as or similar to the arc chamber 299 shown in FIGS. 2A to 2C. Forming 508 an arc chamber around the weld plate such that a cavity of the plunger tube is interconnected to the port and the arc chamber by air pathways may be carried out by welding the housing to the weld plate.

The method of FIG. 5 also includes positioning 510 an arc shield within the arc chamber. For example, the arc shield may be the same as or similar to the arc shield 216 shown in FIGS. 2A to 2C. Positioning 510 an arc shield within the arc chamber may be carried out by aligning the arc shield around the shaft assembly and above the weld plate.

In the example method of FIG. 5, at least one of the arc shield, the shaft assembly, or the upper static core include one or more vent pathways positioned within the air pathways interconnecting the port, the arc chamber, and the plunger tube.

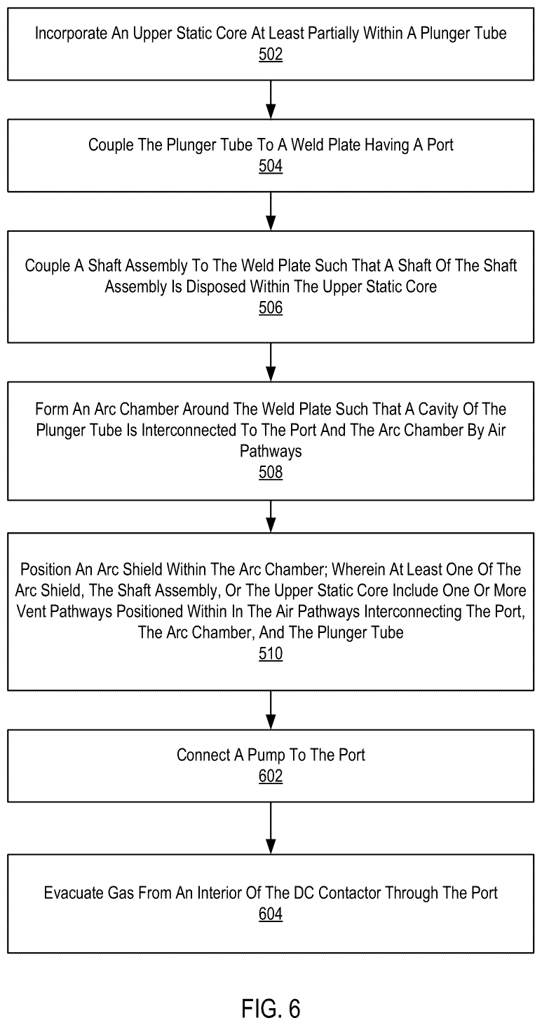

For further explanation, FIG. 6 sets forth a flow chart of an example method for manufacturing a DC contactor with improved evacuation air pathways in accordance with the present disclosure. The method of FIG. 6 is similar to the method of FIG. in that the method of FIG. 6 includes all of the elements of FIG. 5. In addition, the method of FIG. 6 also includes connecting 602 a pump to the port. For example, a suitable pump for evacuating air and water from DC contactor chambers may be a two-stage rotary vane vacuum pump with the capability to handle both gas and small amounts of vapor. This type of pump is effective for applications requiring rapid evacuation and low pressure, as it creates a strong vacuum that can efficiently remove air and moisture from enclosed spaces. Connecting 602 a pump to the port may be carried out by coupling one end of a hose to the port and the other end of the hose to the intake of the pump.

The method of FIG. 6 also includes evacuating 604 gas from an interior of the DC contactor through the port. Evacuating 604 gas from an interior of the DC contactor through the port may be carried out by turning on the pump and pumping gas out of the DC contactor through the port.

In view of the foregoing, improving vacuum evacuation speed on DC contactors include providing vent pathways to facilitate air flow between a port in weld plate of or other exterior surface DC contactor and the arc chamber and the plunger tube for a faster and more complete evacuation. Increased vacuum results in shorter vacuum evacuation times and a lower residual amount of oxygen and water vapor in the DC contactor. As such, the purge process during the manufacturing process to remove oxygen and water vapor from the contactor before sealing it is shortened. Further, the vent pathways increase the removal of oxygen and water vapor, which mitigates oxidation of the conductive copper elements and keeps the contact resistance low for the life of the product.

The flowchart and diagrams in the Figures illustrate the architecture, functionality, and operation of implementations of apparatus and methods according to various embodiments of the present disclosure. In some alternative implementations, the functions noted in the blocks or step in the method may occur out of the order noted in the figures. For example, two blocks shown in succession may, in fact, be performed substantially concurrently, or the blocks may sometimes be performed in the reverse order, depending on the functionality involved.

Advantages and features of the present disclosure can be further described by the following statements:

1. A direct current (DC) contactor assembly with improved evacuation air pathways, the assembly comprising: a port; an arc chamber; a plunger tube having a cavity that is interconnected to the port and the arc chamber by air pathways; an upper static core disposed at least partially within the plunger tube; a shaft assembly coupled to a shaft disposed within the upper static core; an arc shield within the arc chamber; and one or more vent pathways in one or more of the arc shield, the shaft assembly, or the upper static core, the one or more vent pathways in the air pathways interconnecting the port, the arc chamber, and the plunger tube.

2. The DC contactor assembly of statement 1, wherein the arc shield includes at least one vent pathway.

3. The DC contactor assembly of statements 1 or 2, wherein the at least one vent pathway is provided on an underside of the arc shield interfacing with a weld plate.

4. The DC contactor assembly of any of statements 1-3, wherein the shaft assembly includes at least one vent pathway.

5. The DC contactor assembly of any of statements 1-4, wherein the at least one vent pathway is provided on an underside of the shaft assembly interfacing with the upper static core.

6. The DC contactor assembly of any of statements 1-5, wherein the upper static core includes at least one vent pathway.

7. The DC contactor assembly of any of statements 1-6, wherein the at least one vent pathway provides a pathway between the cavity in the plunger tube and the arc chamber.

8. The DC contactor assembly of any of statements 1-7, wherein the one or more vent pathways are configured such that gas within the arc chamber and the plunger tube is evacuated through the one or more vent pathways and the port.

9. The DC contactor assembly of any of statements 1-8, wherein the one or more vent pathways are provided in each of the arc shield, the shaft assembly, and the upper static core.

10. The DC contactor assembly of any of statements 1-9 further comprising: at least one stationary main contact; and a moveable main contact coupled to the shaft, wherein the shaft moves the moveable main contact between an open position and a closed position with respect to the at least one stationary main contact.

11. The DC contactor assembly of any of statements 1-10 further comprising: one or more springs to apply a force directed to separating the moveable main contact from the at least one stationary main contact.

12. A method of manufacturing a direct current (DC) contactor assembly with improved evacuation air pathways, the method comprising: incorporating an upper static core at least partially within a plunger tube; coupling the plunger tube to a weld plate having a port; coupling a shaft assembly to the weld plate such that a shaft of the shaft assembly is disposed within the upper static core; forming an arc chamber around the weld plate such that a cavity of the plunger tube is interconnected to the port and the arc chamber by air pathways; and positioning an arc shield within the arc chamber; wherein at least one of the arc shield, the shaft assembly, or the upper static core include one or more vent pathways positioned within in the air pathways interconnecting the port, the arc chamber, and the plunger tube.

13. The method of statement 12 further comprising: connecting a pump to the port; evacuating gas from an interior of the DC contactor through the port; and subsequent to evacuating the gas from the interior of the DC contactor through the port, creating a hermetically sealed enclosure for the arc chamber and the plunger tube by sealing the port.

14. The method of statement 12 or 13, wherein the arc shield includes at least one vent pathway.

15. The method of any of statements 12-14, wherein the at least one vent pathway is provided on an underside of the arc shield interfacing with the weld plate.

16. The method of any of statements 12-15, wherein the shaft assembly includes at least one vent pathway.

17. The method of any of statements 12-16, wherein the at least one vent pathway is provided on an underside of the shaft assembly interfacing with the upper static core.

18. The method of any of statements 12-17, wherein the upper static core includes at least one vent pathway.

19. The method of any of statements 12-18, wherein the at least one vent pathway provides a pathway between the cavity in the plunger tube and the arc chamber.

20. The method of any of statements 12-19, wherein the one or more vent pathways are provided in each of the arc shield, the shaft assembly, and the upper static core.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A direct current (DC) contactor assembly with improved evacuation air pathways, the assembly comprising:
a port;
an arc chamber;
a plunger tube having a cavity that is interconnected to the port and the arc chamber by air pathways;
an upper static core disposed at least partially within the plunger tube;
a shaft assembly coupled to a shaft disposed within the upper static core;
an arc shield within the arc chamber; and
one or more vent pathways in one or more of the arc shield, the shaft assembly, or the upper static core, the one or more vent pathways in the air pathways interconnecting the port, the arc chamber, and the plunger tube.

2. The DC contactor assembly of claim 1, wherein the arc shield includes at least one vent pathway.

3. The DC contactor assembly of claim 2, wherein the at least one vent pathway is provided on an underside of the arc shield interfacing with a weld plate.

4. The DC contactor assembly of claim 1, wherein the shaft assembly includes at least one vent pathway.

5. The DC contactor assembly of claim 4, wherein the at least one vent pathway is provided on an underside of the shaft assembly interfacing with the upper static core.

6. The DC contactor assembly of claim 1, wherein the upper static core includes at least one vent pathway.

7. The DC contactor assembly of claim 6, wherein the at least one vent pathway provides a pathway between the cavity in the plunger tube and the arc chamber.

8. The DC contactor assembly of claim 1, wherein the one or more vent pathways are configured such that gas within the arc chamber and the plunger tube is evacuated through the one or more vent pathways and the port.

9. The DC contactor assembly of claim 1, wherein the one or more vent pathways are provided in each of the arc shield, the shaft assembly, and the upper static core.

10. The DC contactor assembly of claim 1 further comprising:
at least one stationary main contact; and
a moveable main contact coupled to the shaft, wherein the shaft moves the moveable main contact between an open position and a closed position with respect to the at least one stationary main contact.

11. The DC contactor assembly of claim 10 further comprising:
one or more springs to apply a force directed to separating the moveable main contact from the at least one stationary main contact.

12. A method of manufacturing a direct current (DC) contactor assembly with improved evacuation air pathways, the method comprising:
incorporating an upper static core at least partially within a plunger tube;
coupling the plunger tube to a weld plate having a port;
coupling a shaft assembly to the weld plate such that a shaft of the shaft assembly is disposed within the upper static core;
forming an arc chamber around the weld plate such that a cavity of the plunger tube is interconnected to the port and the arc chamber by air pathways; and
positioning an arc shield within the arc chamber;
wherein at least one of the arc shield, the shaft assembly, or the upper static core include one or more vent pathways positioned within in the air pathways interconnecting the port, the arc chamber, and the plunger tube.

13. The method of claim 12 further comprising:
connecting a pump to the port;
evacuating gas from an interior of the DC contactor through the port; and
subsequent to evacuating the gas from the interior of the DC contactor through the port, creating a hermetically sealed enclosure for the arc chamber and the plunger tube by sealing the port.

14. The method of claim 12, wherein the arc shield includes at least one vent pathway.

15. The method of claim 14, wherein the at least one vent pathway is provided on an underside of the arc shield interfacing with the weld plate.

16. The method of claim 12, wherein the shaft assembly includes at least one vent pathway.

17. The method of claim 16, wherein the at least one vent pathway is provided on an underside of the shaft assembly interfacing with the upper static core.

18. The method of claim 12, wherein the upper static core includes at least one vent pathway.

19. The method of claim 18, wherein the at least one vent pathway provides a pathway between the cavity in the plunger tube and the arc chamber.

20. The method of claim 12, wherein the one or more vent pathways are provided in each of the arc shield, the shaft assembly, and the upper static core.
